(19) United States
(12) Patent Application Publication
(10) Pub. No.: US 2025/0094047 A1
(43) Pub. Date: Mar. 20, 2025

(54) DUAL COMPRESSION IN MEMORY DEVICES

(71) Applicant: Micron Technology, Inc., Boise, ID (US)

(72) Inventors: Marco Sforzin, Cernusco Sul Naviglio Mi (IT); Rishabh Dubey, Agrate Brianza (IT); Daniele Balluchi, Cernusco Sul Naviglio Mi (IT); Danilo Caraccio, Milano (IT); Emanuele Confalonieri, Segrate (IT); Nicola Del Gatto, Cassina de' Pecchi (IT)

(21) Appl. No.: 18/782,539

(22) Filed: Jul. 24, 2024

(30) Foreign Application Priority Data
Sep. 18, 2023 (IN) 202311062641

(51) Int. Cl. G06F 3/06

(52) U.S. Cl. CPC G06F 3/0608; G06F 3/061; G06F 3/0659; G06F 3/0673

(57) ABSTRACT

A variety of applications can include a memory device implementing a dual compression scheme. A memory subsystem of the memory device can be arranged into multiple regions. A first region of the memory subsystem can be used to store non-compressible data. A second region can be used to store compressible data. The second region can have a first subregion and a second subregion. The first subregion can be used to accept compressible data as non-compressed data corresponding to a compression ratio being less than a threshold compression ratio. The second subregion can be used to accept compressed data corresponding to a compression ratio being greater than the threshold compression ratio. Additional apparatus, systems, and methods are disclosed.

### PRIORITY APPLICATION

This application claims the benefit of priority to Indian Patent Application number 202311062641, filed Sep. 18, 2023, which is incorporated herein by reference in its entirety.

### FIELD OF THE DISCLOSURE

Embodiments of the disclosure relate generally to electronic devices and, more specifically, to storage memory devices and operation thereof.

### BACKGROUND

Memory devices are typically provided as internal, semiconductor, integrated circuits in computers or other electronic devices in a variety of manufactured products. There are many different types of memory, including volatile and non-volatile memory. Volatile memory requires power to maintain its data, and examples of volatile memory include random-access memory (RAM), dynamic random-access memory (DRAM), static RAM (SRAM), and synchronous dynamic random-access memory (SDRAM), among others. Non-volatile memory can retain stored data when not powered, and examples of non-volatile memory include flash memory, read-only memory (ROM), electrically erasable programmable ROM (EEPROM), erasable programmable ROM (EPROM), resistance variable memory, such as phase-change random-access memory (PCRAM), resistive random-access memory (RRAM), magnetoresistive random-access memory (MRAM), and three-dimensional (3D) XPoint™ memory, among others.

The various types of memories can be used in applications in which manufacturers of consumer products use architectures for memory devices, which architectures can include one or more memory subsystems having multiple individual storage memory media in which the memory device interacts with a host device to store user data in the one or more memory subsystems of the memory device. The host device and the memory devices can operate using one or more protocols that can include standardized protocols. Operation and properties of memory devices and other electronic devices in systems can be improved by enhancements to the procedures and design of these electronic devices for their introduction into the systems for which the electronic devices are intended.

### BRIEF DESCRIPTION OF THE DRAWINGS

The drawings, which are not necessarily drawn to scale, illustrate generally, by way of example, but not by way of limitation, various embodiments discussed in the present document.

FIG. 1 is illustrates example effects of compression for a compression ratio threshold equal to two, according to various embodiments.

FIG. 2 illustrates an example memory medium of a memory device arranged into multiple regions, according to various embodiments.

FIG. 3 illustrates an example defragmentation of subregions of the memory medium of FIG. 2, according to various embodiments.

FIG. 4 illustrates a representation of an example system including a memory device implementing a dual compression ratio scheme, according to various embodiments.

FIG. 5 is a plot of expansion of memory capacity as a function of a fraction of patterns with compression ratio of at least two, according to various embodiments.

FIG. 6 is a plot of expansion of memory capacity as a function of a fraction of patterns for different compression ratios, according to various embodiments.

FIG. 7 is a flow diagram of features of an example method of directing data within a memory device, according to various embodiments.

FIG. 8 is a flow diagram of features of an example method of operating a memory device, according to various embodiments.

FIG. 9 illustrates a block diagram of example component features of a compute express link system that includes a dual compression scheme for user data, according to various embodiments.

FIG. 10 illustrates an example of the compress region manager of the compute express link controller of FIG. 9, according to various embodiments.

FIG. 11 illustrates an embodiment of an example of the table manager of the compress region manager of FIG. 7, according to various embodiments.

FIG. 12 is a block diagram of an example system including a host that operates with a memory device having one or more memory media, where the memory device can implement a dual compression scheme for user data, according to various embodiments.

### DETAILED DESCRIPTION

The following detailed description refers to the accompanying drawings that show, by way of illustration and not limitation, various embodiments in which an invention can be practiced. These embodiments are described in sufficient detail to enable those skilled in the art to practice these and other embodiments. Other embodiments may be utilized, and structural, logical, mechanical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

To improve physical space utilization in a memory device, a data compression feature may be implemented in the memory device to compress data received from a host. The memory device can include one or more memory media to store user data. This feature can be structured to compress data while writing the host data and decompress compressed data while reading in response to a host read request. The compression of user data can change the target capacity of the memory device and provide better physical capacity utilization compared to memory devices without compression. The compression can be characterized by a data compression ratio or simply a compression ratio (CR), which compression ratio can depend on the nature of the block of data used as the basis for storing data in the memory device. A CR is defined herein as the ratio between the uncompressed size of a given set of data and the compressed size of a given set of data.

The memory device can be realized in a number of different memory device architectures. For example, the compression can be conducted in, but is not limited to, a compute express link (CXL) memory device, a solid-state drive (SSD), or other memory device. One or more memory devices may be coupled to a host, for example, a host computing device to store data, commands, and/or instructions for use by the host while the computer or electronic system is operating. Data, commands, or instructions can be transferred between the host and the one or more memory devices during operation of a computing or other electronic system.

Various protocols or standards can be applied to facilitate communication between a host and one or more other devices such as memory devices, memory buffers, accelerators, or other input/output devices. For example, an unordered protocol such as CXL can be used to provide high-bandwidth and low-latency connectivity. Other protocols can be used alternatively to or in conjunction with CXL.

CXL is an open standard interconnect configured for high-bandwidth, low-latency connectivity between host devices and other devices such as accelerators, memory buffers, and other input/output (I/O) devices. CXL was designed to facilitate high-performance computational workloads by supporting heterogeneous processing and memory systems. CXL enables coherency and memory semantics on top of peripheral component interconnect express (PCIe)-based I/O semantics for optimized performance.

CXL can be used in applications such as artificial intelligence, machine learning, analytics, cloud infrastructure, edge computing devices, communication systems, and elsewhere. Data processing in such applications can use various scalar, vector, matrix, and spatial architectures that can be deployed in a central processing unit (CPU), a graphics processing unit (GPU), a field-programmable gate array (FPGA), a digital signal processors (DSP), an application-specific integrated circuit (ASIC), other programmable logic devices, smart network interface cards (NICs), or other accelerators that can be coupled using a CXL link. A processing module, such as a CPU, can be realized as a host device or host processor in the architecture in which the CPU is structured.

CXL supports dynamic multiplexing using a set of protocols that includes input/output (CXL.io, based on PCIe), caching (CXL.cache), and memory (CXL.memory) semantics. CXL can be used to maintain a unified, coherent memory space between the CPU and any memory on the attached CXL device. This configuration allows the CPU and the CXL device to share resources and operate on the same memory region for higher performance, reduced data movement, and reduced software stack complexity. In an example, the CPU can be primarily responsible for maintaining or managing coherency in a CXL environment. Accordingly, CXL can be leveraged to help reduce device cost and complexity, as well as overhead traditionally associated with coherency across an I/O link.

CXL runs on PCIe physical layer (PHY) and provides full interoperability with PCIe. A CXL device can start link training with a PCIe generation 1 data rate and can negotiate CXL as its operating protocol if its link partner supports CXL. CXL can be used as an operating protocol, for example, using an alternate protocol negotiation mechanism defined in the PCIe 5.0 specification. Devices and platforms can thus more readily adopt CXL by leveraging the PCIe infrastructure without having to design and validate the PHY, channel, channel extension devices, or other upper layers of PCIe.

CXL technology can maintain memory coherency between the CPU memory space and memory on attached devices, which enables resource sharing for higher performance, reduces software stack complexity, and lowers overall system cost. Three primary types of devices can employ a CXL interconnect protocol. Type 1 devices can include accelerators such as smart NICs that typically lack local memory. Via CXL, these type 1 devices can communicate with memory of the host processor to which it is coupled. Type 1 devices can use CXL.io+CXL.cache protocols. Type 2 devices can include GPUs, ASICs, and FPGAs that are equipped with instrumentalities such as, but not limited to, double data rate (DDR) memory or high bandwidth memory (HBM) and can use CXL to make the memory of the host processor locally available to an accelerator and make the memory of the accelerator locally available to the host processor. The type 2 devices can also be co-located in the same cache-coherent domain and help boost heterogeneous workloads. Type 2 devices can use CXL.io+CXL.cache+CXL.memory protocols. Type 3 devices can include memory devices that can be attached via CXL to provide additional bandwidth and capacity to host processors. The type of memory is independent of the main memory of the host. Type 3 devices can use CXL.io+CXL.memory protocols.

In various embodiments, a CR threshold (CRₜₕ) can be defined and a pattern of data can be compressed for storage only if the pattern of data after compression has a CR≥CRₜₕ. Optionally, the comparison with CRₜₕ can be set to whether the compressed data has a CR>CRₜₕ. If the CR<CRₜₕ, the data compressed for the compression calculation can be stored in its original version as uncompressed data. Typically, this method can provide interesting benefits if the number of typical application patterns with CR at least equal to CRₜₕ is significant. CRₜₕ can be set at a value of two or a power of two. A power of two is a number of the form 2ⁿ, where n is an integer. For example, CRₜₕ can be, but is not limited to, four or eight. This scheme is a dual compression scheme. Depending on the memory device, a multi-compression procedure can be implemented beyond a dual compression scheme.

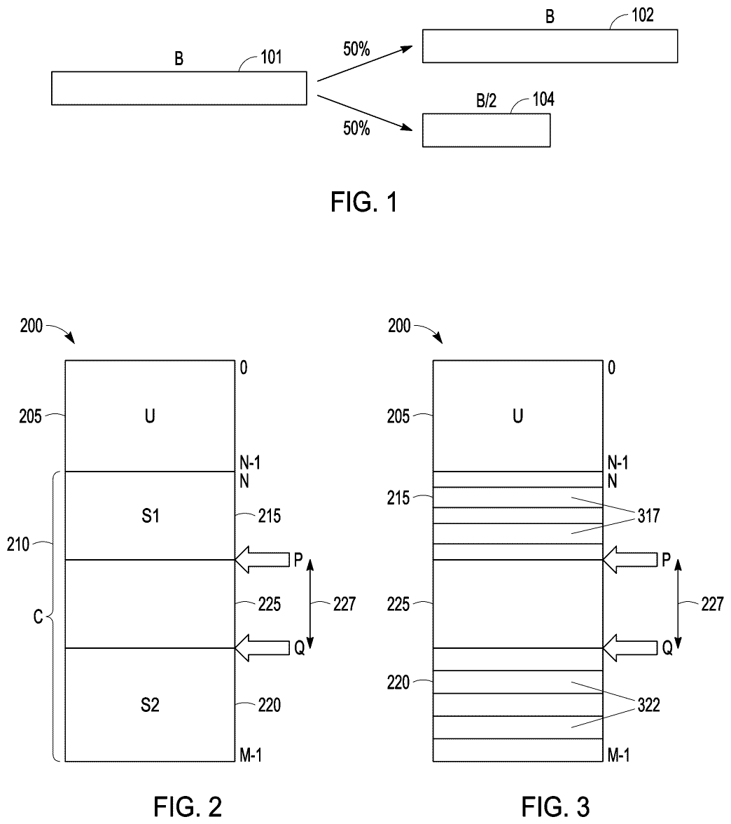

FIG. 1 illustrates effects of compression for a CRₜₕ equal to 2. A pattern 101 of size B is received for storage in a memory medium from a host device and a compressed pattern can be a saturated pattern 102 to B or a saturated pattern 104 to B/2. If 50% of the host patterns can be compressed with CR≥2, then the capacity of the memory medium available to the host device increases by 33% with respect to the raw capacity of the memory medium. This increase can be shown in the following manner. With N total patterns of size B being the amount that can be stored in a medium, the total number of patterns that can be stored in the same medium with 50% of the patterns compressed with CR=2 and 50% of the patterns uncompressed can be given by N′ in the following numerical evaluation.

NB=(N′/2)B+(N′/2)(B/2)

N′/N=4/3,

which indicates that N′ is 33% greater than N.

FIG. 2 illustrates an embodiment of an example memory medium 200 of a memory device arranged into multiple regions. Memory medium 200 can include two regions that are defined as uncompressed (U) region 205 and compressed (C) region 210. Each of the multiple regions can be defined by a set of consecutive physical addresses (PAs) for each of the multiple regions, and the progression from one of the multiple regions to the next region follows a PA of the one region to the next PA that is in the next region. With respect to a memory device, host-supplied addresses and pages are virtual addresses (VAs) and virtual pages (VPs), which VAs are mapped by the memory device to PAs. A PA is an address that the memory device uses to point to a memory medium (for example, a memory die or a packaged memory die), row, and column to store one or more bits of data, where the pointing mechanism can include a calculation dependent on the type of memory used for the memory medium. U region 205 and C region 210 can be defined at power-on of the memory device. The establishment of the multiple regions can be made at the initial power-on in the lifetime of the memory device. The generation of the multiple regions can be made by a controller of the memory device executing instructions stored in the memory device.

C region 210 can be arranged into multiple subregions. The multiple subregions of C region 210 can include two subregions, S1 subregion 215 and S2 subregion 220, where these subregions are effectively defined by a threshold compression ratio CRₜₕ. CRₜₕ can be a power of two. A subregion 225 can be generated between S1 subregion 215 and S2 subregion 220. S1 subregion 215 can be defined by CRₜₕ as being a region that accepts data as non-compressed data for which a CR for the data of S1 subregion 215 is less than CRₜₕ, which is written as CR<CRₜₕ. Non-compressed data of S1 subregion 215 is compressible data that is selectively not compressed for storage. S2 subregion 220 can be defined by CRₜₕ as being a region that accepts data in compressed format for which a CR for the compressed data is greater than CRₜₕ, which is written as CR≥CRₜₕ. Optionally, depending on design considerations, a controller of a memory device can set data with a CR=CRₜₕ as part of S1 subregion 215 or S2 subregion 220. Subregion 225 can be formed as a region of memory medium 200 in which data is not actively stored as part of subregion 225, but can be used in a defragmentation of S1 subregion 215 or S2 subregion 220.

U region 205 can be positioned in memory medium 200 at PAs ranging from a 0^{th} PA to and including a (N−1)^{th} PA (PAs [0,N−1]), where N can be defined at power-on of the memory device of memory medium 200. S1 subregion 215 can be defined starting from the N^{th} PA that immediately follows the (N−1)^{th} PA. S2 subregion 220 can be defined starting from the (M−1)^{th} PA, where M is the total number of PAs in the memory medium 200.

S1 subregion 215, S2 subregion 220, and subregion 225 can have varying sizes. S1 subregion 215 increases by increasing the PA of uncompressed data added to S1 subregion 215. S1 subregion 215 has a current upper boundary indicated and tracked by a pointer P, where upper is defined relative to the values of the PAs of S1 subregion 215. S2 subregion 220 increases by decreasing the PA of compressed data added to S2 subregion 220. S2 subregion 220 has a current lower boundary indicated and tracked by a pointer Q, where lower is defined relative to the values of the PAs of S2 subregion 220. If a difference 227 between values of pointer Q and pointer P is less than a specified limit ((Q-P)<specified limit), a defragmentation process of S1 subregion 215 or S2 subregion 220 can be triggered.

FIG. 3 illustrates an embodiment of an example defragmentation of subregions of memory medium 200 of FIG. 2. Defragmentation in a memory medium, which can be referred to as defrag, is a compaction in the memory medium. Defragmentation is a process of freeing up storage space. As shown in the example of FIG. 3, S1 subregion 215 has invalid pages 317 and S2 subregion 220 has invalid pages 322. Invalid pages 317 are removed and valid data of S1 subregion 215 below the PAs of invalid pages 317 are moved up to the PAs of invalid 317 and pointer P is moved up. Invalid pages 322 are removed and valid data of S2 subregion 220 above the PAs of invalid 322 are moved down to the PAs of invalid pages 322 and pointer Q is moved down. The difference 227 between pointer Q and pointer P is increased. Such a defrag can be straightforward because invalid positions can be easily replaced with valid blocks higher in S1 subregion 215 or lower in S2 subregion 220 positions.

With CR of the compressed data being equal to two or a power of two, such as four or eight, the addressing can be similar to that of using a logical to physical (L2P) table. Simplification can also arise due to the use of one effective compression-ratio, CRₜₕ, to manage, and the growth of S2 subregion 220 is from top to bottom. A drawback can occur for a low value of the mean CR such as all the received data having a CR<CRₜₕ, resulting in the data not being not compressed.

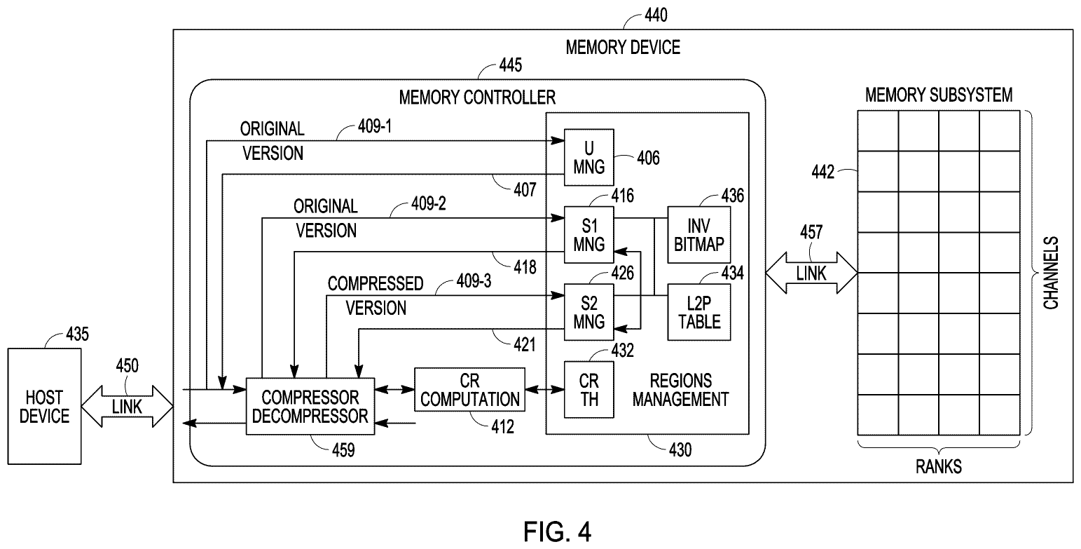

FIG. 4 illustrates a representation of an embodiment of an example system 400 including a memory device 440 implementing a dual compression ratio scheme. System 400 includes a host device 435 that transmits data to memory device 440 via a link 450. Memory device 440 can be structured with a memory controller 445 coupled to a memory subsystem 442 via link 457 to operate identical or similar to the compression and use of memory medium 200 of FIGS. 2 and 3. Memory controller 445 can include a compressor/decompressor 459, a CR computation 412, and a regions management 430. Each of compressor/decompressor 459, CR computation 412, and regions management 430 can be realized by one or more of hardware to hold and process data or stored instructions executable by processing circuitry of memory controller 445 to execute respective functions of a dual compression scheme to store data from host device 435 into memory subsystem 442.

Regions management 430 can be structured to control storage of data in memory subsystem 442 according to an uncompressed region to accept non-compressible data, a subregion to accept compressible data that is non-compressed in response to a CR of the compressible data being less than a CRₜₕ, and a subregion to accept compressed data in response to a CR of the compressed data being greater than or equal to the CRₜₕ. Non-compressible data of the uncompressed region is data that is identified as data that is not to be compressed. The identification can be provided in a communication between host device 435 and memory device 440. The uncompressed region to accept non-compressible data can be structured identical or similar to U region 205 of memory medium 200 of FIGS. 2 and 3. The subregion to accept compressible data as non-compressed data can be structured identical or similar to S1 subregion 215 of memory medium 200 of FIGS. 2 and 3. The subregion to accept compressed data can be structured identical or similar to S2 subregion 220 of memory medium 200 of FIGS. 2 and 3. Regions management 430 can include a CRₜₕ 432, a manager for the uncompressed region (U MNG) 406, a manager for the subregion to accept compressible data as non-compressed data (S1 MNG) 416, a manager for the subregion to accept compressed data (S2 MNG) 426, a L2P table 434, and an invalidity (INV) bitmap 436.

U MNG 406 can manage data received from host device 435 that is not to be compressed. U MNG 406 can use a line 407 or other mechanism to flag the data that is not to be compressed. Since the data is not to be compressed, original version 409-1 of the received data not to be compressed can be stored in memory subsystem 442 via link 457.

S1 MNG 416 can manage compressible data received from host device 435 and can manage the storage of such compressible data as non-compressed data in memory subsystem 442 via link 457. The received compressible data is compressed by compressor/decompressor 459 and a CR is generated for the received compressible data using CR computation 412. The generated CR is compared to a value of a CRₜₕ stored in CRₜₕ 432. The comparison can be conducted by CR computation 412 or CRₜₕ 432. In response to a determination that the generated CR is less than CRₜₕ from the comparison, the original version 409-2 of compressible data can be stored in memory subsystem 442. The CRₜₕ can be provided to S1 MNG 416 for the management of the compressible data, which can include interacting with compressor/decompressor 459 over a line 418 or other mechanism to flag that this compressible data can be stored as the original version 409-2.

S2 MNG 426 can manage compressible data received from host device 435 and can manage the storage of such compressible data as compressed data in memory subsystem 442 via link 457. The received compressible data is compressed by compressor/decompressor 459 and a CR is generated for the received compressible data using CR computation 412. The generated CR is compared to a value of a CRₜₕ stored in CRₜₕ 432. The comparison can be conducted by CR computation 412 or CRₜₕ 432. In response to a determination that the generated CR is greater than or equal to CRₜₕ from the comparison, the original version is compressed to provide compressed version 409-3 and can be stored in memory subsystem 442. The CRₜₕ can be provided to S2 MNG 416 for the management of the compressed data, which can include interacting with compressor/decompressor 459 over a line 421 or other mechanism to flag that this compressible data can be stored as compressed version 409-3.

S1 MNG 416 can be configured to manage the region of memory subsystem 442 that contains compressible data as non-compressed data with respect to invalid pages and a boundary pointer for this region. The invalidity of pages in this region can be tracked in INV bitmap 436 and PAs of the pages can be tracked in L2P table 434. L2P table 434 stores a L2P map to access the correct data in memory subsystem 442. INV bitmap 436 can store a bitmap of an invalid block and can contribute to defining the L2P map of L2P table 434. S1 MNG 416 can use INV bitmap 436 and L2P table 434 to control defragmentation of the region that contains compressible data as non-compressed data. S1 MNG 416 can update the boundary pointer for this region.

S2 MNG 426 can be configured to manage the region of memory subsystem 442 that contains compressed data with respect to invalid pages and a boundary pointer for this region. The invalidity of pages in this region can be tracked in INV bitmap 436 and PAs of the pages can be tracked in L2P table 434. S2 MNG 426 can use INV bitmap 436 and L2P table 434 to control defragmentation of the region that contains compressed data. S2 MNG 416 can update the boundary pointer for this region.

The boundary pointers maintained by S1 MNG 416 and S2 MNG 426 can be used by regions management 430 to initiate the defragmentation in S1 MNG 416 and S2 MNG 426. The initiation of the defragmentation can be trigged by the difference between the two boundaries being less than a specified limit. The boundaries can be end PAs of consecutive PAs of the two regions.

The uncompressed region, the compressible region, and the compressed region of memory subsystem 442 can be arranged among ranks and channels of memory subsystem 442, with PAs associated with these regions arranged as consecutive regions. Non-compressible data of the uncompressed region, non-compressed data of the compressible subregion, and compressed data of the compressed region of memory subsystem 442 can be provided to host device 453 via link 450. Each format of the data can be processed through compressor/decompressor 459 prior to being transmitted via link 450. Alternatively, non-compressible data and non-compressed data can be provided to link 450 bypassing compressor/decompressor 459.

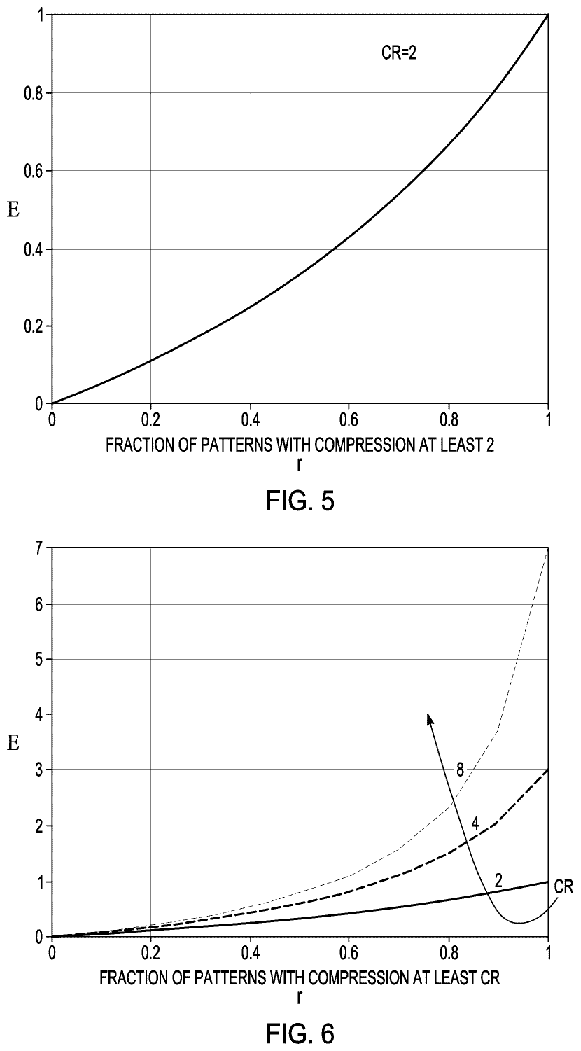

FIG. 5 is a plot of expansion (E) of memory capacity as a function of fraction (r) of patterns with compression of at least two. As previously noted, in the case of 50% of patterns being compressed with CR at least 2, the resulting expansion is 33%. In general, suppose that r is the fraction of patterns that are compressed with CR at least two. With N total patterns of size B being the amount that can be stored in a medium, the total number of patterns that can be stored in the same medium with a given percentage of the patterns compressed with CR=2 and (1−the given percentage) of the patterns uncompressed can be given by N′ in the following numerical evaluation.

NB=(1−r)N′B+rN′(B/2),

which provides

(N′/N)=1/(1−r+(r/2))=2/(2−r)

The expansion of capacity is then given by

E=(2/(2−r)−1)=r/(2−r).

FIG. 6 is a plot of expansion (E) of memory capacity as a function of fraction (r) of patterns for different CRs. With the CR=2 in the above equations replaced by a varying CR, the following relationships occur.

NB=(1−r)N′B+rN′(B/CR),

which provides

N′/N=1/(1−r+(r/CR)=CR/(CR−(CR−1)r)

The expansion of capacity is then given by

E=CR/(CR−(CR−1)r)−1=(CR−1)r/(CR−(CR−1)r).

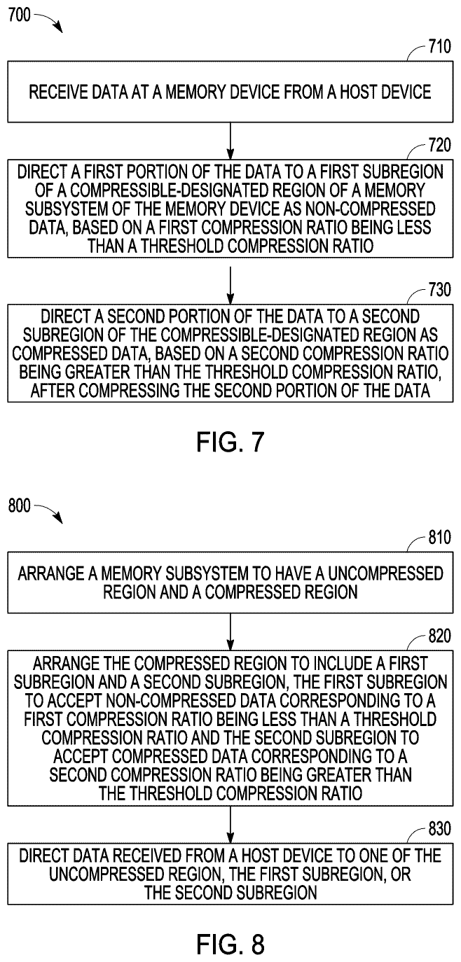

FIG. 7 is a flow diagram of features of an embodiment of an example method 700 of directing data within a memory device. Method 700 can be implemented by a controller of the memory device. The controller can execute instructions stored in one or more components of the memory device to direct data within the memory device. The controller can be implemented by processing circuitry, which can include, but is not limited to, one or more processing devices. At 710, data is received at the memory device from a host device. The data can be received over different periods of time. At 720, a first portion of the data is directed to a first subregion of a compressible-designated region of a memory subsystem of the memory device as non-compressed data. This routing is based on a first CR being less than a CRₜₕ. The compressible-designated region is defined to store user data that is compressible data that has not been flagged as do not compress. The first CR is the compression of the first portion of the data, where the first CR can be determined prior to directing the first portion to the first subregion.

At 730, a second portion of the data is directed to a second subregion of the compressible-designated region as compressed data. This routing is based on a second CR being greater than the CRₜₕ, after compressing the second portion of the data. The second CR is the compression of the second portion of the data, where the second CR can be determined prior to directing the second portion to the second subregion. In response to a CR of a third portion of the data being equal to the CRₜₕ, the third portion can be directed to the second subregion or to the first subregion. With the CRₜₕ being 2, 4, or 8, the third portion can be directed to the second subregion.

Variations of method 700 or methods similar to method 700 can include a number of different embodiments that may be combined depending on the application of such methods and/or the architecture of systems including an electronic device for which such methods are implemented. Such methods can include directing another portion of the data to a region of the memory subsystem as non-compressible data, where the region is designated to store non-compressible data. Non-compressible data includes data specified as do not compress. Directing the other portion of the data can be conducted based on an identification that flags the other portion of the data from the host device as data not to be compressed. Variations can include the CRₜₕ being set equal to a power of two.

FIG. 8 is a flow diagram of features of an embodiment of an example method 800 of operating a memory device. Method 800 can be implemented by a controller of the memory device. The controller can execute instructions stored in one or more components of the memory device to operate the memory device. The controller can be implemented by processing circuitry, which can include, but is not limited to, one or more processing devices. At 810, a memory subsystem is arranged to have an uncompressed region and a compressed region. The uncompressed region is configured to store non-compressible data and the compressed region is configured to store compressible data. Non-compressible data includes data specified as do not compress.

At 820, the compressed region is arranged to include a first subregion and a second subregion. The first subregion is arranged to accept non-compressed data corresponding to a first CR being less than a CRₜₕ. The second subregion is arranged to accept compressed data corresponding to a second CR being greater than the CRₜₕ. The first CR is the compression of the first portion of the data, where the first CR can be determined prior to directing the second portion to the second subregion. The second CR is the compression of the second portion of the data, where the second CR can be determined prior to directing the second portion to the second subregion. In response to a CR of another portion of the data being equal to the CRₜₕ, this other portion can be directed to the second subregion or to the first subregion, depending on the architecture of the memory device. For example, with the CRₜₕ being 2, 4, or 8, the other portion can be directed to the second subregion.

At 830, data received from a host device is directed to one of the uncompressed region, the first subregion, or the second subregion. The routing of the data into one of the three regions can be based on a CR of the received data. The CR can be determined prior to directing the data to storage and can be subjected to a comparison with the CRₜₕ.

Variations of method 800 or methods similar to method 800 can include a number of different embodiments that may be combined depending on the application of such methods and/or the architecture of systems including an electronic device for which such methods are implemented. Such methods can include defining the uncompressed region and the compressed region at power-on of the memory device. The memory device can have M total number of PAs, where M is a positive integer. The uncompressed region can be positioned in PAs from a 0th PA to and including a (N−1)^{th} PA, N being a positive integer. The first subregion can be defined starting from a N^{th} PA and the second subregion can be defined starting from a (M−1)^{th} PA at power-on of the memory device. The PAs of the memory device range from the 0^{th} PA to the N^{th} PA to the (M−1)^{th} PA consecutively.

Variations of method 800 or methods similar to method 800 can include arranging the compressed region to include arranging a third subregion between the first subregion and the second subregion. The third subregion can have a first boundary at an end of the first subregion opposite the uncompressed region and a second boundary at the beginning of the second subregion. In operation, the first subregion can increase by increasing a PA from the first boundary and the second subregion can increase by decreasing a PA from the second boundary. A first pointer can be set at the first boundary and a second pointer can be set at the second boundary. The first pointer and the second pointer can be used to control initiation of defragmentation of the compressed region. Defragmentation of the compressed region can be initiated in response to a difference between a value of the second pointer and a value of the first pointer being less than a specified limit.

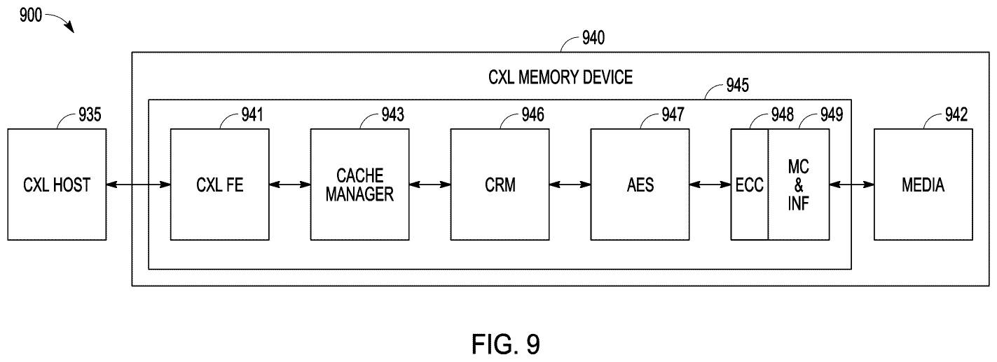

FIG. 9 is a block diagram of an embodiment of example component features of a CXL system 900 that includes a dual compression scheme for user data. CXL system 900 can include a CXL host 935 and a CXL memory device 940 that can operate in accordance with CXL protocols. CXL memory device 940 can include a controller 945 that interfaces with CXL host 935 and with media 942 of CXL memory device 940 to write user data directed from CXL host 935 to media 942 using one or more write requests and to read user data from media 942 for CXL host 935 using one or more read requests. The execution of write requests can be performed using the dual compression scheme, as taught herein. The execution of read requests can be performed that retrieve user data from regions of media 942, where the regions have been defined in implementation of the dual compression scheme. The dual compression scheme can provide a relatively high speed approach to storing data with compression that is suitable for CXL memory device 940

Controller 945 can include a CXL front end (FE) 941 to interface with CXL host 935 using CXL protocols and a cache manager 943 to manage flow of user data associated with read and write requests received form CXL host 935. The user data can be stored in media 942, where media 942 can be structured as one or more memory structures arranged as channels of data storage. The user data can be processed with an Advanced Encryption Standard (AES) 947 and ECC 948. Processing of user data with ECC 948 by a memory controller (MC) and interface (INF) 949 that controls input and output of the user data with respect to media 942. The user data operated on by AES 947, ECC 948, and MC & INF 949 can be compressed data. Compressing user data and uncompressing user data can be controlled by a compression region manager (CRM) 946.

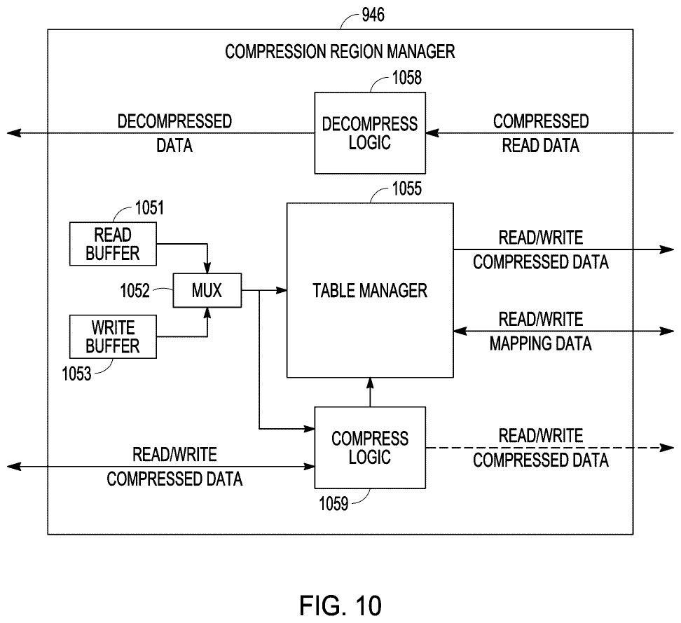

FIG. 10 illustrates an embodiment of an example of CRM 946 of CXL controller 945 of FIG. 9. CRM 946 can include a read buffer 1051 to handle user data for a read request and a write buffer 1053 to handle user data for a write request. Read buffer 1051 and write buffer 1053 can be first in, first out (FIFO) structures that can be realized in a number of formats including one or more registers or one or more other buffering structures that can cache user data. Data from read buffer 1051 and write buffer 1053 can be directed to a table manager 1055 and compress logic 1059 by a multiplexer (MUX) 1052. CRM 946 also includes decompress logic 1058 to uncompress, using logic circuitry within decompress logic 1058, received compressed read data, where the compressed read data is compressed data from media 942 received in response to a read request. Compress logic 1059 can use received CR data to compress input user data using logic circuitry within compress logic 1059, if the input user data meets the criterion for compression. The criterion can be provided in the CR data or from table manager 1055. Compress logic 1059 can provide the compressed data to table manager 1055, which can output the compressed data, or can, alternatively or in conjunction with table manager 1055, output the compressed data. Compress logic 1059 can also provide CR data for subsequent operations associated with compression. Compress logic 1059 may be structured to make compression calculations. Table manager 1055, in addition to operating with respect to output of read/write compressed data, can operate on read/write mapping data to receive and output the read/write mapping data. Table manager 1055 can operate to manage a dual compression scheme with compressed data as taught herein.

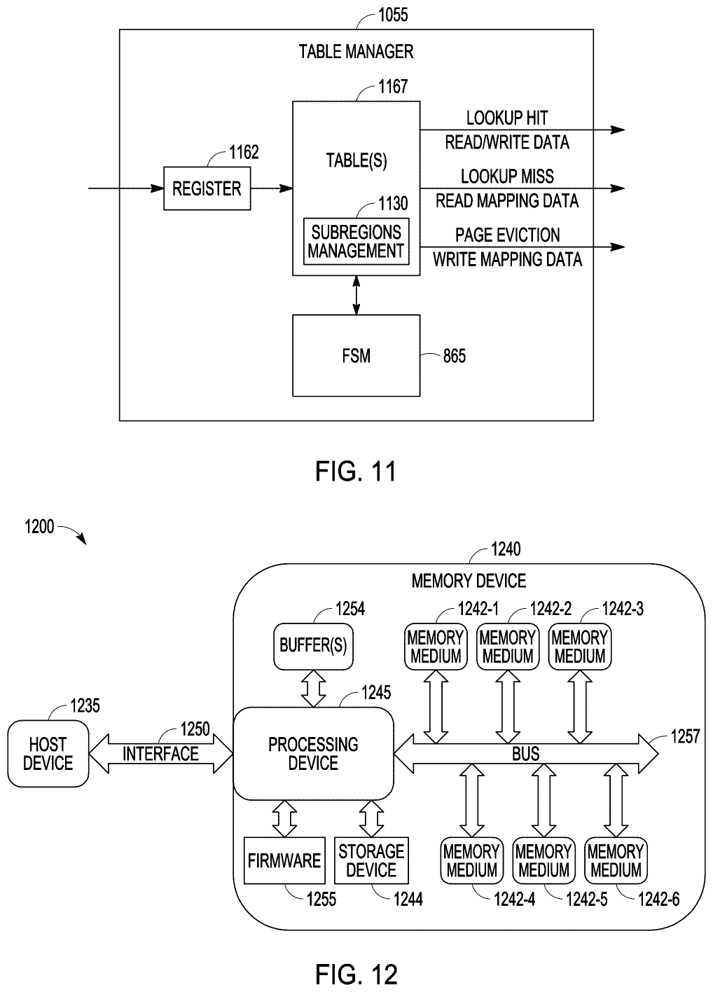

FIG. 11 illustrates an embodiment of an example of table manager 1055 of CRM 946 of FIG. 10. Table manager 1055 can include register 1162. Register 1162 can be a FIFO structure that can be realized in a number of formats including one or more register structures or one or more other buffering structures that can hold data. Table manager 1055 can include one or more tables (table(s)) 1167. Table(s) 1167 can include a table for mapping and looking-up information on cached data along with updating maps associated with read and write requests. Table(s) 1167 can include subregions management 1130, which can be structured or can operate similar to or identical to 430 of FIG. 4. Table(s) 1167 can operate with a free space manager (FSM) 1165 and subregions management 1130 to make PAs available for use in an invalidation process, including eviction of pages of data from identified memory locations in response to a write operation, as taught herein. Table(s) 1167 can include mapping tables that can update information translating received VA with associated PAs. Data that is read frequently can be cached and table(s) 1167 can be used to determine if such data is currently part of a read or write (read/write) request. Determination that current data of a read/write request is cached is a hit and determination that current data of a read/write request is not cached is a miss. Table(s) 1167 can provide data from looking-up hit data, data from looking-up miss data, and data of page eviction associated with mapping of write operations.

FIG. 12 is a block diagram of an embodiment of example system 1200 including a host device 1235 that operates with a memory device 1240 having one or more memory media, where memory device 1240 can implement a dual compression scheme for user data in applications for which memory device 1240 is implemented. The dual compression scheme can be implemented using techniques associated with FIGS. 2 and 3, the methods of FIGS. 7 and 8, and functions associated with the structures of FIGS. 9-11. System 1200 and its components can be structured in a number of different arrangements. For example, system 1200 can be arranged with a variation of the types of components that comprise host device 1235, an interface 1250, memory device 1240, memory media 1242-1, 1242-2, 1242-3, 1242-4, 1242-5, and 1242-6, a processing device 1245, one or more buffers (buffer(s)) 1254, firmware 1255, storage device 1244, and a bus 1257.

Host device 1235 is coupled to memory device 1240 by interface 1250, where host device 1235 is a host device that can comprise one or more processors, which can vary in type compatible with interface 1250 and memory device 1240. Memory device 1240 can include processing device 1245 coupled to memory media 1242-1, 1242-2, 1242-3, 1242-4, 1242-5, and 1242-6 by bus 1257, where each memory medium has one or more arrays of memory cells. Memory media 1242-1, 1242-2, 1242-3, 1242-4, 1242-5, and 1242-6 may be realized as memory structures that can be selected from different types of memory. Though six memory media are shown in FIG. 12, memory device 1240 can be implemented with more or fewer than six memory media, that is, memory device 1240 can comprise one or more memory media. The memory media can be realized in a number of formats including, but not limited to, a plurality of memory dies or a plurality of packaged memory dies.

Processing device 1245 can include processing circuitry or be structured as one or more processors. Processing device 1245 can be structured as a memory system controller for memory device 1240. Processing device 1245 can be implemented in a number of different formats. Processing device 1245 can include or be structured as one or more types of processors compatible with memory media 1242-1, 1242-2, 1242-3, 1242-4, 1242-5, and 1242-6. Processing device 1245 can include processing circuitry that can be structured with a DSP, an ASIC, other type of processing circuit, including a group of processors or multi-core devices, or combinations thereof.

Memory device 1240 can comprise firmware 1255 having code executable by processing device 1245 to at least manage the memory media 1242-1, 1242-2, 1242-3, 1242-4, 1242-5, and 1242-6. Firmware 1255 can reside in a storage device of memory device 1240 coupled to processing device 1245. Firmware 1255 can be coupled to the processing device 1245 using bus 1257 or some other interface on the memory device 1240. Alternatively, firmware 1255 can reside in processing device 1245 or can be distributed in memory device 1240 with firmware components, such as, but not limited to, code, including one or more components in processing device 1245. Firmware 1255 can include code having instructions, executable by processing device 1245, to operate on memory media 1242-1, 1242-2, 1242-3, 1242-4, 1242-5, and 1242-6. The instructions can include instructions to execute operations to store user data as compressed data on one or more of memory media 1242-1, 1242-2, 1242-3, 1242-4, 1242-5, and 1242-6 using a dual compression scheme as taught herein.

Memory device 1240 can include a storage device 1244 that can be implemented to provide data or parameters used in maintenance of memory device 1240. Storage device 1244 can include one or more of a non-volatile memory structure or a RAM. Though storage device 1244 is external to processing device 1245 in memory device 1240 in FIG. 12, storage device 1244 may be integrated into processing device 1245. Storage device 1244 can be coupled to bus 1257 for communication with other components of memory device 1240. Alternatively, storage device 1244 can be coupled with processing device 1245 in which processing device 1245 handles communications between storage device 1244 and other components of the memory device 1240. Storage device 1244 can be coupled to bus 1257 and to processing device 1245.

Each of memory media 1242-1, 1242-2, 1242-3, 1242-4, 1242-5, and 1242-6, firmware 1255, storage device 1244, and other memory structures of memory device 1240 are implemented as machine-readable medium. Non-limiting examples of machine-readable media can include solid-state memories, optical media, and magnetic media. Specific examples of non-transitory machine-readable media can include non-volatile memory, such as semiconductor memory media (e.g., EPROM, EEPROM) and flash memory devices; magnetic disks, such as internal hard disks and removable disks; magneto-optical disks; and compact disc-ROM (CD-ROM) and digital versatile disc-read only memory (DVD-ROM) disks.

Firmware 1255, storage device 1244, or other components of memory device 1240 can include hardware or instructions to implement a dual compression scheme similar or identical to the dual compression scheme associated with FIGS. 2 and 3. Firmware 1255, storage device 1244, or other components of memory device 1240 can have instructions, executable by processing device 1245, to operate on user data to store the user data in one or more of memory media 1242-1, 1242-2, 1242-3, 1242-4, 1242-5, and 1242-6 in a compressed format according to a dual compression scheme, as taught herein. Firmware 1255, storage device 1244, or other components of memory device 1240 can have instructions, executable by processing device 1245, to operate on uncompressible data, non-compressed data, and compressed user data to read and generate uncompressed user data from one or more of memory media 1242-1, 1242-2, 1242-3, 1242-4, 1242-5, and 1242-6.

Processing device 1245 can execute instructions stored on one or more components in memory device 1240, which instructions, when executed by processing device 1245, cause memory device 1240 to perform operations. The operations can include operations of method 700, method 800, methods similar to method 700 or method 800, associated with such methods, and functions of structures associated with FIGS. 2-4 and 9-11.

The operations can include operations to direct data within memory device 1240. Operations to direct data within memory device 1240 can include receiving data at memory device 1240 from host device 1235. The operations can include directing a first portion of the data to a first subregion of a compressible-designated region of a memory subsystem of the memory device as non-compressed data. The memory subsystem can include one or more of memory media 1242-1, 1242-2, 1242-3, 1242-4, 1242-5, and 1242-6. The routing can be based on a first CR being less than a CRₜₕ, where the compressible-designated region is defined to store user data that is compressible data. The operations can include directing a second portion of the data to a second subregion of the compressible-designated region as compressed data. The routing of the compressed data can be based on a second CR being greater than the CRₜₕ, after compressing the second portion of the data.

Operations can include directing a third portion of the data to the second subregion or to the first subregion, based on a CR, corresponding to the third portion, being equal to the CRₜₕ. The CRₜₕ can be equal to a power of two.

Operations can include directing another portion of the data to a region of the memory subsystem as non-compressible data, where the region is designated to store non-compressible data. Directing the other portion of the data can be conducted based on an identification that flags the other portion of the data from host device 1235 as data not to be compressed.

Processing device 1245 can execute instructions stored on one or more components in memory device 1240, which instructions, when executed by processing device 1245, cause memory device 1240 to perform operations. The operations can include operations to operate memory device 1240 with respect to multiple regions of one or more of memory media 1242-1, 1242-2, 1242-3, 1242-4, 1242-5, and 1242-6.

The operations can include arranging a memory subsystem to have an uncompressed region and a compressed region, where the uncompressed region is arranged to store non-compressible data and the compressed region is arranged to store compressible data. The memory subsystem can include one or more of memory media 1242-1, 1242-2, 1242-3, 1242-4, 1242-5, and 1242-6. The operations can include arranging the compressed region to include a first subregion and a second subregion. The first subregion can be arranged to accept non-compressed data corresponding to a first CR being less than a CRₜₕ. The second subregion can be arranged to accept compressed data corresponding to a second CR being greater than the CRₜₕ. The operations can include directing data received from host device 1235 to one of the uncompressed region, the first subregion, or the second subregion.

Operations to arrange a memory subsystem can include defining the uncompressed region and the compressed region at power-on of the memory device. Operations to arrange a memory subsystem can include memory device 1240 having M total number of PAs, M being a positive integer, the uncompressed region being positioned in PAs from a 0^{th} PA to and including a (N−1)^{th} PA. The first subregion can be defined starting from a N^{th} PA, the second subregion can be defined starting from a (M−1)^{th} PA at power-on of memory device 1240. The PAs can range from the 0^{th} PA to the N^{th} PA to the (M−1)^{th} PA consecutively.

Operations to arrange a memory subsystem can include arranging the compressed region by arranging a third subregion between the first subregion and the second subregion. The third subregion can have a first boundary at an end of the first subregion opposite the uncompressed region and a second boundary at a beginning of the second subregion. The first subregion can increase by increasing a PA from the first boundary and the second subregion can increase by decreasing a PA from the second boundary. Operations to arrange a memory subsystem can include setting a first pointer at the first boundary and a second pointer at the second boundary, and using the first pointer and the second pointer to control initiation of defragmentation of the compressed region.

Operations to arrange a memory subsystem can include initiating defragmentation of the compressed region in response to a difference between a value of the second pointer and a value of the first pointer being less than a specified limit. The defragmentation of the compressed region can be a defragmentation of the first subregion. The defragmentation of the compressed region can be a defragmentation of the second subregion. The defragmentation of the compressed region can be a defragmentation of the first subregion and the second subregion.

The following are example embodiments of devices and methods, in accordance with the teachings herein.

An example memory device 1 can comprise a memory subsystem and a controller. The controller can be arranged to configure a first region of the memory subsystem to store non-compressible data and a second region to store compressible data, the second region having a first subregion and a second subregion, the first subregion to accept non-compressed data corresponding to a first CR being less than a CRₜₕ, the second subregion to accept compressed data corresponding to a second CR being greater than the CRₜₕ.

An example memory device 2 can include features of example memory device 1 and can include the controller being arranged to configure the second subregion to accept compressed data or the first subregion to accept non-compressed data in response to a CR being equal to the CRₜₕ.

An example memory device 3 can include features of any of the preceding example memory devices and can include the controller being configured to store data from a host device as uncompressed data in the first region in response to an identification that flags the data from the host device as data not to be compressed.

An example memory device 4 can include features of any of the preceding example memory devices and can include the first region being defined in the memory device at initial power-on of the memory device.

An example memory device 5 can include features of any of the preceding example memory devices and can include the CRₜₕ being equal to a power of two.

An example memory device 6 can include features of any of the preceding example memory devices and can include the first subregion having a varying upper boundary and the second subregion having a varying lower boundary.

An example memory device 7 can include features of example memory device 6 and any of the preceding example memory devices and can include the controller being configured to initiate a defragmentation in response to a determination that a difference between the lower boundary and the upper boundary is less than a specified limit.

An example memory device 8 can include features of any of the preceding example memory devices and can include the second region including a third subregion between the first subregion and the second subregion.

In an example memory device 9, any of the memory devices of example memory devices 1 to 8 may include memory devices incorporated into an electronic apparatus further comprising a host processor and a communication bus extending between the host processor and the memory device.

In an example memory device 10, any of the memory devices of example memory devices 1 to 9 may be modified to include any structure presented in another of example memory device 1 to 9.

In an example memory device 11, any apparatus associated with the memory devices of example memory devices 1 to 10 may further include a machine-readable storage device configured to store instructions as a physical state, wherein the instructions may be used to perform one or more operations of the apparatus.

In an example memory device 12, any of the memory devices of example memory devices 1 to 11 may be operated in accordance with any of the below methods 1 to 9 of directing data within a memory device and example methods 1 to 12 of operating a memory device.

An example method 1 of directing data within a memory device can comprise receiving data at the memory device from a host device; directing a first portion of the data to a first subregion of a compressible-designated region of a memory subsystem of the memory device as non-compressed data, based on a first CR being less than a CRₜₕ, the compressible-designated region being defined to store user data that is compressible data; and directing a second portion of the data to a second subregion of the compressible-designated region as compressed data, based on a second CR being greater than the CRₜₕ, after compressing the second portion of the data.

An example method 2 of directing data within a memory device can include features of example method 1 of directing data within a memory device and can include directing a third portion of the data to the second subregion or to the first subregion, based on a CR, corresponding to the third portion, being equal to the CRₜₕ.

An example method 3 of directing data within a memory device can include features of any of the preceding example methods of directing data within a memory device and can include directing another portion of the data to a region of the memory subsystem as non-compressible data, the region being designated to store non-compressible data.

An example method 4 of directing data within a memory device can include features of method 3 of directing data within a memory device and any of the preceding example methods of directing data within a memory device and can include directing the other portion of the data based on an identification that flags the other portion of the data from the host device as data not to be compressed.

An example method 5 of directing data within a memory device can include features of any of the preceding example methods of directing data within a memory device and can include the CRₜₕ being equal to a power of two.

In an example method 6 of directing data within a memory device, any of the example methods 1 to 5 of directing data within a memory device may be performed in operating an electronic apparatus further comprising a host processor and a communication bus extending between the host processor and the memory device.

In an example method 7 of directing data within a memory device, any of the example methods 1 to 6 of directing data within a memory device may be modified to include operations set forth in any other of example methods 1 to 6.

In an example method 8 of directing data within a memory device, any of the example methods 1 to 7 of directing data within a memory device may be implemented at least in part through use of instructions stored as a physical state in one or more machine-readable storage devices.

An example method 9 of directing data within a memory device can include features of any of the preceding example methods 1 to 8 of directing data within a memory device and can include performing functions associated with any features of example memory devices 1 to 12 of operating a memory device or directing data within a memory device.

An example method 1 of operating a memory device can comprise arranging a memory subsystem to have an uncompressed region and a compressed region, the uncompressed region to store non-compressible data and the compressed region to store compressible data; arranging the compressed region to include a first subregion and a second subregion, the first subregion to accept non-compressed data corresponding to a first CR being less than a CRₜₕ and the second subregion to accept compressed data corresponding to a second CR being greater than the CRₜₕ; and directing data received from a host device to one of the uncompressed region, the first subregion, or the second subregion.

An example method 2 of operating a memory device can include features of example method 1 of operating a memory device and can include defining the uncompressed region and the compressed region at power-on of the memory device.

An example method 3 of operating a memory device can include features of any of the preceding example methods of operating a memory device and can include the memory device having M total number of PAs, M being a positive integer, the uncompressed region being positioned in PAs from a 0^{th} PA to and including a (N−1)^{th} PA, the first subregion being defined starting from a N^{th} PA, the second subregion being defined starting from a (M−1)^{th} PA at power-on of the memory device, the PAs ranging from the 0^{th} PA to the N^{th} PA to the (M−1)^{th} PA consecutively.

An example method 4 of operating a memory device can include features of any of the preceding example methods of operating a memory device and can include arranging the compressed region to include arranging a third subregion between the first subregion and the second subregion, the third subregion having a first boundary at an end of the first subregion opposite the uncompressed region and a second boundary at a beginning of the second subregion.

An example method 5 of operating a memory device can include features of example method 4 of operating a memory device and any of the preceding example methods of operating a memory device and can include the first subregion increasing by increasing a PA from the first boundary and the second subregion increasing by decreasing a PA from the second boundary.

An example method 6 of operating a memory device can include features of example method 4 of operating a memory device and any of the preceding example methods of operating a memory device and can include setting a first pointer at the first boundary and a second pointer at the second boundary, and using the first pointer and the second pointer to control initiation of defragmentation of the compressed region.

An example method 7 of operating a memory device can include features of example method 6 of operating a memory device and any of the preceding example methods of operating a memory device and can include initiating defragmentation of the compressed region in response to a difference between a value of the second pointer and a value of the first pointer being less than a specified limit.

In an example method 8 of operating a memory device, any of the example methods 1 to 7 of operating a memory device may be performed in operating an electronic apparatus further comprising a host processor and a communication bus extending between the host processor and the memory device.

In an example method 9 of operating a memory device, any of the example methods 1 to 8 of operating a memory device may be modified to include operations set forth in any other of example methods 1 to 8 of operating a memory device.

In an example method 10 of operating a memory device, any of the example methods 1 to 9 of operating a memory device may be implemented at least in part through use of instructions stored as a physical state in one or more machine-readable storage devices.

An example method 11 of operating a memory device can include features of any of the preceding example methods 1 to 10 of operating a memory device and can include performing functions associated with any features of example memory device 1 to 12.

An example method 12 of operating a memory device can include features of any of the preceding example methods 1 to 11 of operating a memory device and example methods 1 to 9 of directing data within a memory device and can include performing functions associated with any features of example memory device 1 to 12.

An example machine-readable storage device storing instructions, that when executed by one or more processors, cause a machine to perform operations, can comprise instructions to perform functions associated with any features of example memory devices 1 to 12 or perform methods associated with any features of example methods 1 to 9 of directing data within a memory device and example methods 1 to 12 of operating a memory device.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description.

What is claimed is:

1. A memory device comprising:
a memory subsystem; and
a controller to configure a first region of the memory subsystem to store non-compressible data and a second region to store compressible data, the second region having a first subregion and a second subregion, the first subregion to accept non-compressed data corresponding to a first compression ratio being less than a threshold compression ratio, the second subregion to accept compressed data corresponding to a second compression ratio being greater than the threshold compression ratio.

2. The memory device of claim 1, wherein the controller is arranged to configure the second subregion to accept compressed data or the first subregion to accept non-compressed data in response to a compression ratio being equal to the threshold compression ratio.

3. The memory device of claim 1, wherein the controller is configured to store data from a host device as uncompressed data in the first region in response to an identification that flags the data from the host device as data not to be compressed.

4. The memory device of claim 1, wherein the first region is defined in the memory device at initial power-on of the memory device.

5. The memory device of claim 1, wherein the threshold compression ratio is equal to a power of two.

6. The memory device of claim 1, wherein the first subregion has a varying upper boundary and the second subregion has a varying lower boundary.

7. The memory device of claim 6, wherein the controller is configured to initiate a defragmentation in response to a determination that a difference between the lower boundary and the upper boundary is less than a specified limit.

8. The memory device of claim 1, wherein the second region includes a third subregion between the first subregion and the second subregion.

9. A method of directing data within a memory device, the method comprising:
receiving data at the memory device from a host device;
directing a first portion of the data to a first subregion of a compressible-designated region of a memory subsystem of the memory device as non-compressed data, based on a first compression ratio being less than a threshold compression ratio, the compressible-designated region being defined to store user data that is compressible data; and
directing a second portion of the data to a second subregion of the compressible-designated region as compressed data, based on a second compression ratio being greater than the threshold compression ratio, after compressing the second portion of the data.

10. The method of claim 9, wherein the method includes directing a third portion of the data to the second subregion or to the first subregion, based on a compression ratio, corresponding to the third portion, being equal to the threshold compression ratio.

11. The method of claim 9, wherein the method includes directing another portion of the data to a region of the memory subsystem as non-compressible data, the region being designated to store non-compressible data.

12. The method of claim 11, wherein directing the other portion of the data is conducted based on an identification that flags the other portion of the data from the host device as data not to be compressed.

13. The method of claim 9, wherein the threshold compression ratio is equal to a power of two.

14. A method of operating a memory device, the method comprising:
arranging a memory subsystem to have an uncompressed region and a compressed region, the uncompressed region to store non-compressible data and the compressed region to store compressible data;
arranging the compressed region to include a first subregion and a second subregion, the first subregion to accept non-compressed data corresponding to a first compression ratio being less than a threshold compression ratio and the second subregion to accept compressed data corresponding to a second compression ratio being greater than the threshold compression ratio; and
directing data received from a host device to one of the uncompressed region, the first subregion, or the second subregion.

15. The method of claim 14, wherein the method includes defining the uncompressed region and the compressed region at power-on of the memory device.

16. The method of claim 14, wherein the memory device has M total number of physical addresses, M being a positive integer, the uncompressed region being positioned in physical addresses from a 0^{th} physical address to and including a (N−1)^{th} physical address, the first subregion being defined starting from a N^{th} physical address, the second subregion being defined starting from a (M−1)^{th} physical address at power-on of the memory device, the physical addresses ranging from the 0th physical address to the N^{th} physical address to the (M−1)^{th} physical address consecutively.

17. The method of claim 14, wherein arranging the compressed region includes arranging a third subregion between the first subregion and the second subregion, the third subregion having a first boundary at an end of the first subregion opposite the uncompressed region and a second boundary at a beginning of the second subregion.

18. The method of claim 17, wherein the first subregion increases by increasing a physical address from the first boundary and the second subregion increases by decreasing a physical address from the second boundary.

19. The method of claim 17, wherein the method includes setting a first pointer at the first boundary and a second pointer at the second boundary, and using the first pointer and the second pointer to control initiation of defragmentation of the compressed region.

20. The method of claim 19, wherein the method includes initiating defragmentation of the compressed region in response to a difference between a value of the second pointer and a value of the first pointer being less than a specified limit.
